(19) United States
(12) Patent Application Publication
(10) Pub. No.: US 2025/0026953 A1
(43) Pub. Date: Jan. 23, 2025

(54) CLEAR COATING COMPOSITION

(71) Applicant: NIPPON PAINT AUTOMOTIVE COATINGS CO., LTD., Hirakata-shi, Osaka (JP)

(72) Inventors: Naoto KOZAKURA, Hirakata-shi, Osaka (JP); Ippei FUKUHARA, Hirakata-shi, Osaka (JP); Takunori MATSUFUJI, Hirakata-shi, Osaka (JP); Katsumi MIZUGUCHI, Hirakata-shi, Osaka (JP); Shinichi HORII, Hirakata-shi, Osaka (JP)

(73) Assignee: NIPPON PAINT AUTOMOTIVE COATINGS CO., LTD., Hirakata-shi, Osaka (JP)

(21) Appl. No.: 18/714,725

(22) PCT Filed: Nov. 4, 2022
(86) PCT No.: PCT/JP2022/041171

§ 371 Date: May 30, 2024

(30) Foreign Application Priority Data
Dec. 17, 2021 (JP) 2021-204948

(51) Int. Cl. C09D 175/06; C09D 7/65

(52) U.S. Cl. CPC C09D 175/06; C09D 7/65

(57) ABSTRACT

Provided is a clear coating composition having a sufficiently low viscosity even being highly solid from which a coating film having a good appearance and high performance can be obtained. A clear coating composition including a hydroxy group-containing acrylic resin (a), a hydroxy group-containing polyester resin (b), a polyol compound (c) other than the hydroxy group-containing acrylic resin (a) and the hydroxy group-containing polyester resin (b), a polyisocyanate compound (d), organic dispersive particles (e), and a cellulose derivative (f), in which the polyol compound (c) has a hydroxyl value of more than 200 mg KOH/g and 1000 mg KOH/g or less and a molecular weight of 100 or more and 1000 or less.

### TECHNICAL FIELD

The present invention relates to a clear coating composition.

### BACKGROUND ART

In the technical field of automobiles and the like, consideration for the natural environment and improvement of the working environment are required. In this regard, Patent Literature 1 discloses a water-borne base coating composition. According to this, reduction in volatile organic compounds (VOC) can be expected.

### CITATIONS LIST

### Patent Literature

Patent Literature 1: JP 2008-138179 A

### SUMMARY OF INVENTION

### Technical Problems

As another approach for VOC reduction, high solids coating materials have attracted attention in the coating of automobile components. High solids coating materials can be applied by using an existing coating line as it is, and thus have a great advantage, in addition to the VOC reduction, in that the coating time can be shortened without making capital investment.

However, high solidification usually increases the viscosity of a coating composition, so that workability and smoothness of a resulting coating film may be deteriorated. When the molecular weight of the resin component to be blended is reduced in order to reduce the viscosity, the hardness and water resistance of a resulting coating film are deteriorated. In addition, due to the reduction in viscosity, appearance abnormality such as sagging of a coating film occurs on a vertical or inclined coated surface, and sufficient coating film performance and appearance quality required for automobile components cannot be obtained.

The present invention is intended to solve the above-mentioned conventional problems, and an object of the present invention is to provide a clear coating composition having a sufficiently low viscosity even being highly solid from which a coating film having a good appearance and high performance can be obtained.

### Solutions to Problems

In order to solve the above-described problems, the present invention provides the following embodiments.

[1]

A clear coating composition including:
a hydroxy group-containing acrylic resin (a);
a hydroxy group-containing polyester resin (b);
a polyol compound (c) other than the hydroxy group-containing acrylic resin (a) and the hydroxy group-containing polyester resin (b);
a polyisocyanate compound (d);
organic dispersive particles (e); and
a cellulose derivative (f),
in which the polyol compound (c) has a hydroxyl value of more than 200 mg KOH/g and 1000 mg KOH/g or less and a molecular weight of 100 or more and 1000 or less.
   [2]

The clear coating composition according to [1], in which
in 100 parts by mass of a total solid content of the hydroxy group-containing acrylic resin (a), the hydroxy group-containing polyester resin (b) and the polyol compound (c),
a solid content of the hydroxy group-containing acrylic resin (a) accounts for 60 parts by mass or more and 95 parts by mass or less,
a solid content of the hydroxy group-containing polyester resin (b) accounts for 4 parts by mass or more and 30 parts by mass or less, and
a solid content of the polyol compound (c) accounts for 1 part by mass or more and 10 parts by mass or less.
   [3]

The clear coating composition according to [1] or [2], in which the polyol compound (c) has an alicyclic hydrocarbon group.

[4]

The clear coating composition according to any one of [1] to [3], in which at least one hydroxy group of the polyol compound (c) is directly bonded to an alicyclic hydrocarbon group or bonded via a hydrocarbon group having 1 or 2 carbon atoms.

[5]

The clear coating composition according to any one of [1] to [4], in which the hydroxy group-containing acrylic resin (a) has a hydroxyl value of 90 mg KOH/g or more and 190 mg KOH/g or less, a weight average molecular weight of 4000 or more and 6000 or less, and a glass transition temperature of 15° C. or higher and 100° C. or lower.

[6]

The clear coating composition according to any one of [1] to [5], in which the hydroxy group-containing polyester resin (b) has a hydroxyl value of 250 mg KOH/g or more and 500 mg KOH/g or less and a weight average molecular weight of 1500 or more and 2500 or less.

[7]

The clear coating composition according to any one of [1] to [6], in which the polyol compound (c) has a molecular weight of 100 or more and 800 or less.

[8]

The clear coating composition according to any one of [1] to [7], in which the cellulose derivative (f) has a number average molecular weight of 10000 or more and 40000 or less and a glass transition temperature of 80° C. or higher.

[9]

The clear coating composition according to any one of [1] to [8], in which the clear coating composition has a solid component concentration of 50% by mass or more.

[16]

The clear coating composition according to any one of [1] to [9], in which a viscosity of the clear coating composition measured by a flow cup method at 23° C. is 30 seconds or less.

### Advantageous Effects of Invention

In accordance with the present invention, provided is a clear coating composition having a sufficiently low viscosity even being highly solid from which a coating film having a good appearance and high performance can be obtained.

### DESCRIPTION OF EMBODIMENTS

Clear coating compositions are to form clear coating films. A clear coating film is usually disposed on the outermost side from an article to be coated. Therefore, the clear coating film is required to have low tack in addition to superior smoothness and hardness. The tack of a coating film surface may occur depending on the composition of the coating composition and curing conditions. For example, when curing proceeds insufficiently as a result of shortening the heating time or lowering the heating temperature in consideration of the environment, tack is likely to occur.

The smoothness of a coating film is also affected by the pot life of the coating material. The pot life is a time during which a mixture of a base agent with a curing agent and the like can be used as a coating material, the time starting with the mixing of the ingredients. When the base agent and the curing agent are mixed, a reaction between them is started, and the curing of the coating composition proceeds. In the curing reaction, the coating composition is increased in viscosity, and the fluidity thereof is eventually lost. When the pot life is short, the viscosity of the coating composition rapidly increases, and the smoothness of a resulting coating film is deteriorated.

In the present embodiment, as a coating film forming component, three kinds of hydroxy group-containing components (namely, the hydroxy group-containing acrylic resin (a), the hydroxy group-containing polyester resin (b), and the polyol compound (c)) are used together with the polyisocyanate compound (d) as a curing agent. As a result, it becomes easy to control the viscosity within an appropriate range even when the coating material is made highly solid. In addition, since the polyol compound (c) has a low molecular weight, the pot life of the clear coating composition is also improved. As a result, the smoothness of a coating film is improved.

The clear coating composition according to the present embodiment also contains the cellulose derivative (f). The cellulose derivative (f) is disposed in the vicinity of a surface layer of a coating film by interaction with the hydroxy group-containing components (a) to (c). Therefore, tack of a coating film surface is reduced.

The clear coating composition according to the present embodiment further contains the organic dispersive particles (e). The organic dispersive particles (e) control the viscosity of the coating composition after its application and thereby reduce appearance abnormality such as sagging. In addition, while the organic dispersive particles (e) inhibit the reaction between the hydroxy group-containing components and the isocyanate compound in the coating composition to enhance the pot life, the organic dispersive particles (e) interact with the hydroxy group-containing components (a) to (c) after coating to enhance the hardness of the coating film.

Hereinafter, the hydroxy group-containing acrylic resin (a), the hydroxy group-containing polyester resin (b), the polyol compound (c), and other coating film forming components containing a hydroxy group (other than curing agents) may be collectively referred to as “hydroxy group-containing components”.

### [Clear Coating Composition]

The clear coating composition according to the present embodiment contains a hydroxy group-containing acrylic resin (a), a hydroxy group-containing polyester resin (b), a polyol compound (c) other than the hydroxy group-containing acrylic resin (a) and the hydroxy group-containing polyester resin (b), a polyisocyanate compound (d), organic dispersive particles (e), and a cellulose derivative (f). The polyol compound (c) has a hydroxyl value of more than 200 mg KOH/g and 1000 mg KOH/g or less and a molecular weight of 100 or more and 1000 or less.

The solid component concentration of the clear coating composition is, for example, 50% by mass or more. The solid component concentration is that of the clear coating composition to be subjected to coating. The clear coating composition to be subjected to coating has been diluted to a viscosity suitable for coating using a diluent component, for example. In accordance with the present embodiment, even when the solid component concentration of the clear coating composition to be subjected to coating is increased as described above, increase in viscosity is inhibited. Accordingly, the smoothness of a resulting coating film is improved.

The solid component concentration of the clear coating composition may be 55% by mass or more, and may be 58% by mass or more. The solid component concentration of the clear coating composition may be 70% by mass or less, and may be 65% by mass or less. In one embodiment, the solid component concentration of the clear coating composition is 50% by mass or more and 70% by mass or less. The solid component of the clear coating composition is all components except diluent components such as a nonaqueous solvent and the like.

The viscosity of the clear coating composition measured by a flow cup method at 23° C. is, for example, 30 seconds or less. The viscosity is one of a clear coating composition to be subjected to coating, and is attained immediately after the preparation of the clear coating composition (specifically, immediately after the curing agent and other components are mixed). Hereinafter, the viscosity described above is referred to as coating viscosity η₀. In accordance with the present embodiment, the coating viscosity η₀ of the clear coating composition can be made low even when the solid component concentration is 50% by mass or more. The coating viscosity η₀ may be 29 seconds or less, and may be 28 seconds or less. The coating viscosity η₀ may be 15 seconds or more, and may be 18 seconds or more. In one embodiment, the coating viscosity η₀ of the clear coating composition measured by a flow cup method at 23° C. is 15 seconds or more and 30 seconds or less.

The viscosity of the clear coating composition is measured using a No 4 Ford Cup at 23° C. in accordance with “3. Flow Cup Method” of JIS K 5600-2-2: 1999. The viscosity is the average value of the viscosities of five different coating compositions having the same configuration.

The pot life of the clear coating composition of the present embodiment is long, and the viscosity is maintained for a long time. For example, the time until the viscosity of the clear coating composition measured by the method described above exceeds 30 seconds (in particular, 28 seconds) is 4 hours or more. Therefore, the viscosity is prevented from rapidly increasing during the step of forming a clear coating film, and deterioration in workability and smoothness is reduced.

### (a) Hydroxy Group-Containing Acrylic Resin

The hydroxy group-containing acrylic resin (a) is a resin to serve as a base of a clear coating film (coating film forming component). The hydroxy group-containing acrylic resin (a) reacts with a polyisocyanate compound (d) to form a crosslinked structure.

The hydroxy group-containing acrylic resin (a) has a plurality of acryloyl groups and one or more (typically, two or more) hydroxy groups in one molecule. The “acrylic resin” is obtained by polymerizing at least one monomer among acrylic acid and esters thereof and methacrylic acid and esters thereof.

The hydroxyl value (OHV) of the hydroxy group-containing acrylic resin (a) is, for example, 90 mg KOH/g or more. Owing to this, a higher crosslinking density is likely to be attained. The hydroxyl value of the hydroxy group-containing acrylic resin (a) may be 100 mg KOH/g or more, and may be 110 mg KOH/g or more. The hydroxyl value of the hydroxy group-containing acrylic resin (a) may be, for example, 190 mg KOH/g or less. Owing to this, hydrophilization of a coating film is inhibited, and the water resistance of a clear coating film is likely to be improved. The hydroxyl value of the hydroxy group-containing acrylic resin (a) may be 180 mg KOH/g or less, and may be 170 mg KOH/g or less. In one embodiment, the hydroxyl value of the hydroxy group-containing acrylic resin (a) is 90 mg KOH/g or more and 180 mg KOH/g or less.

The hydroxyl value can be determined by a neutralization titration method using an aqueous potassium hydroxide solution described in JIS K 0070.

The weight average molecular weight of the hydroxy group-containing acrylic resin (a) is, for example, 4000 or more. Owing to this, the hardness and weatherability of a resulting coating film are likely to be improved. The weight average molecular weight of the hydroxy group-containing acrylic resin (a) may be 4200 or more, and may be 4300 or more. The weight average molecular weight of the hydroxy group-containing acrylic resin (a) may be, for example, 6000 or less. Owing to this, it becomes easier to inhibit an excessive increase in viscosity of the coating composition. The weight average molecular weight of the hydroxy group-containing acrylic resin (a) may be 5800 or less, and may be 5500 or less. In one embodiment, the weight average molecular weight of the hydroxy group-containing acrylic resin (a) is 4000 or more and 6000 or less.

The weight average molecular weight can be calculated based on the molecular weight of standard polystyrene from a chromatogram measured with a gel permeation chromatograph. As the gel permeation chromatograph, for example, HLC-8200 (manufactured by Tosoh Corporation) is used. The measurement conditions using this are as follows.
Column: TSgel Super Multipore HZ-M, three columns
Developing solvent: tetrahydrofuran
Column inlet oven: 40° C.
Flow rate: 0.35 ml
Detector: differential refractive index detector (RI)
Standard polystyrene: PS oligomer kit manufactured by Tosoh Corporation

The glass transition temperature (Tg) of the hydroxy group-containing acrylic resin (a) is, for example, 15° C. or higher. Owing to this, the stain resistance, the scratch resistance, and the hardness of a resulting coating film are likely to be improved. The Tg of the hydroxy group-containing acrylic resin (a) may be 18° C. or higher, and may be 20° C. or higher. The Tg of the hydroxy group-containing acrylic resin (a) is, for example, 100° C. or lower. Owing to this, the quick-drying property of the clear coating composition is likely to be improved. The Tg of the hydroxy group-containing acrylic resin (a) may be 95° C. or lower, and may be 90° C. or lower. In one embodiment, the Tg of the hydroxy group-containing acrylic resin (a) is 15° C. or higher and 100° C. or lower.

The glass transition temperature (Tg) is determined by the following method using a differential scanning calorimeter (DSC). The hydroxy group-containing acrylic resin (a) is subjected to (step 1) a step of raising the temperature from 20° C. to 150° C. at a temperature raising rate of 10° C./min, (step 2) a step of lowering the temperature from 150° C. to |50° C. at a temperature lowering rate of 10° C./min after step 1, and (step 3) a step of raising the temperature from-50° C. to 150° C. at a temperature raising rate of 10° C./min after step 2. The value obtained from the chart during the temperature rise in step 3 is the Tg of the hydroxy group-containing acrylic resin (a). As the DSC, for example, a thermal analyzer SSC5200 (manufactured by Seiko Instruments & Electronics Ltd.) is used.

From the viewpoint of hardness, the hydroxy group-containing acrylic resin (a) may have a hydroxyl value of 90 mg KOH/g or more and 190 mg KOH/g or less, a weight average molecular weight of 4000 or more and 6000 or less, and a Tg of 15° C. or higher and 100° C. or lower.

The acid value (AV) of the hydroxy group-containing acrylic resin (a) may be 2 mg KOH/g or more and 30 mg KOH/g or less. Owing to this, favorable smoothness of a resulting coating film is likely to be attained. Furthermore, when the coating composition is applied to another uncured coating film, the occurrence of mix of phases is likely to be inhibited. The acid value of the hydroxy group-containing acrylic resin (a) may be 3 mg KOH/g or more. The acid value of the hydroxy group-containing acrylic resin (a) may be 20 mg KOH/g or less, and may be 15 mg KOH/g or less. The acid value can be determined by the same method as that used for the hydroxyl value.

The solid content of the hydroxy group-containing acrylic resin (a) accounting for in 100 parts by mass of the total solid content of the hydroxy group-containing components is, for example, 60 parts by mass or more. Owing to this, the smoothness of a resulting coating film is likely to be improved. The solid content of the hydroxy group-containing acrylic resin (a) may be 65 parts by mass or more, and may be 70 parts by mass or more. The amount of the hydroxy group-containing acrylic resin (a) is, for example, 95 parts by mass or less. Owing to this, the drying property of the clear coating composition is likely to be improved. The solid content of the hydroxy group-containing acrylic resin (a) may be 92 parts by mass or less, and may be 90 parts by mass or less. In one embodiment, the solid content of the hydroxy group-containing acrylic resin (a) accounting for in 100 parts by mass of the total solid content of the hydroxy group-containing components is 60 parts by mass or more and 95 parts by mass or less.

Examples of the starting monomer of the hydroxy group-containing acrylic resin (a) include acrylic acid hydroxy esters such as 2-hydroxyethyl acrylate and 4-hydroxybutyl acrylate; and methacrylic acid hydroxy esters such as 2-hydroxyethyl methacrylate and 4-hydroxybutyl methacrylate. Furthermore, as necessary, acrylic acid; acrylic acid esters such as methyl acrylate, butyl acrylate, isobutyl acrylate, t-butyl acrylate, 2-ethylhexyl acrylate, lauryl acrylate, and isobornyl acrylate; methacrylic acid; methacrylic acid esters such as methyl methacrylate, butyl methacrylate, isobutyl methacrylate, t-butyl methacrylate, 2-ethylhexyl methacrylate, lauryl methacrylate, and isobornyl methacrylate; ethylenically unsaturated monomers having an aromatic ring such as styrene; and so on may be used. These are used singly or two or more of them are used in combination. A commercially available hydroxy group-containing acrylic resin (a) may be used.

### (b) Hydroxy Group-Containing Polyester Resin

The hydroxy group-containing polyester resin (b) is also a coating film forming component. The hydroxy group-containing polyester resin (b) reacts with a polyisocyanate compound (d) to form a crosslinked structure. The hydroxy group-containing polyester resin (b) has a plurality of ester linkages and one or more hydroxy groups.

The hydroxy group-containing acrylic resin (a) is likely to increase the viscosity of the clear coating composition. On the other hand, the hydroxy group-containing polyester resin (b) generally has a low viscosity and is likely to increase the hydroxyl value. Use of the hydroxy group-containing polyester resin (b) in combination makes it possible to improve the crosslinking density while inhibiting increase in viscosity.

The hydroxyl value of the hydroxy group-containing polyester resin (b) is, for example, 250 mg KOH/g or more. Owing to this, a higher crosslinking density is likely to be attained. The hydroxyl value of the hydroxy group-containing polyester resin (b) may be 260 mg KOH/g or more, and may be 270 mg KOH/g or more. The hydroxyl value of the hydroxy group-containing polyester resin (b) is, for example, 500 mg KOH/g or less. Owing to this, hydrophilization of a coating film is inhibited, and the water resistance of a clear coating film is likely to be improved. The hydroxyl value of the hydroxy group-containing polyester resin (b) may be 480 mg KOH/g or less, and may be 450 mg KOH/g or less. In one embodiment, the hydroxyl value of the hydroxy group-containing acrylic resin (a) is 250 mg KOH/g or more and 500 mg KOH/g or less.

The weight average molecular weight of the hydroxy group-containing polyester resin (b) is, for example, 1500 or more. Owing to this, the hardness and weatherability of a resulting coating film are likely to be improved. The weight average molecular weight of the hydroxy group-containing polyester resin (b) may be 1600 or more, and may be 1700 or more. The weight average molecular weight of the hydroxy group-containing polyester resin (b) is, for example, 2500 or less. Owing to this, it becomes easier to inhibit an excessive increase in viscosity of the coating composition. The weight average molecular weight of the hydroxy group-containing polyester resin (b) may be 2400 or less, and may be 2300 or less. In one embodiment, the weight average molecular weight of the hydroxy group-containing polyester resin (b) is 1500 or more and 2500 or less.

From the viewpoint of viscosity, the hydroxy group-containing polyester resin (b) may have a hydroxyl value of 250 mg KOH/g or more and 500 mg KOH/g or less and a weight average molecular weight of 1500 or more and 2500 or less.

The solid content of the hydroxy group-containing polyester resin (b) accounting for in 100 parts by mass of the total solid content of the hydroxy group-containing components is, for example, 4 parts by mass or more. Owing to this, the smoothness of a resulting coating film is likely to be improved. The solid content of the hydroxy group-containing polyester resin (b) may be 7 parts by mass or more, and may be 10 parts by mass or more. The solid content of the hydroxy group-containing polyester resin (b) is, for example, 30 parts by mass or less. Owing to this, the drying property of the clear coating composition is likely to be improved. The solid content of the hydroxy group-containing polyester resin (b) may be 25 parts by mass or less, and may be 20 parts by mass or less. In one embodiment, the solid content of the hydroxy group-containing polyester resin (b) accounting for in 100 parts by mass of the total solid content of the hydroxy group-containing components is 4 parts by mass or more and 30 parts by mass or less.

The hydroxy group-containing polyester resin (b) is obtained, for example, via polycondensation (ester reaction) between a polyhydric alcohol and a polybasic acid or an anhydride thereof. A commercially available hydroxy group-containing polyester resin (b) may be used.

The polyhydric alcohol is not particularly limited, and examples thereof include ethylene glycol, diethylene glycol, polyethylene glycol, propylene glycol, dipropylene glycol, polypropylene glycol, neopentyl glycol, 1,2-butanediol, 1,3-butanediol, 2,3-butanediol, 1,4-butanediol, 1,5-pentanediol, 1,6-hexanediol, hydrogenated bisphenol A, hydroxyalkylated bisphenol A, 1,4-cyclohexanedimethanol, 2,2-dimethyl-3-hydroxypropyl-2,2-dimethyl-3-hydroxypropionate, 2,2,4-trimethyl-1,3-pentanediol, N,N-bis-(2-hydroxyethyl)dimethylhydantoin, polytetramethylene ether glycol, polycaprolactone polyol, glycerin, sorbitol, trimethylolethane, trimethylolpropane, trimethylolbutane, hexanetriol, pentaerythritol, dipentaerythritol, and tris-(hydroxyethyl)isocyanate. These are used singly or two or more of them are used in combination.

The polybasic acid or an anhydride thereof is not particularly limited, and examples thereof include phthalic acid, phthalic anhydride, tetrahydrophthalic acid, tetrahydrophthalic anhydride, hexahydrophthalic acid, hexahydrophthalic anhydride, methyltetrahydrophthalic acid, methyltetrahydrophthalic anhydride, hymic anhydride, trimellitic acid, trimellitic anhydride, pyromellitic acid, pyromellitic anhydride, isophthalic acid, terephthalic acid, maleic acid, maleic anhydride, fumaric acid, itaconic acid, adipic acid, azelaic acid, sebacic acid, succinic acid, succinic anhydride, lactic acid, dodecenylsuccinic acid, dodecenylsuccinic anhydride, cyclohexane-1,4-dicarboxylic acid, and endic anhydride. These are used singly or two or more of them are used in combination.

The hydroxy group-containing polyester resin may be modified using lactone, fat, fatty acid, melamine resin, urethane resin, or the like. The fat or fatty acid is not particularly limited, and examples thereof include oils or fats such as castor oil, dehydrated castor oil, coconut oil, corn oil, cottonseed oil, linseed oil, perilla oil, poppy seed oil, safflower oil, soybean oil, and tung oil, and fatty acid extracted from these oils or fats.

### (c) Polyol Compound

The polyol compound (c) is also a coating film forming component. The polyol compound (c) reacts with the polyisocyanate compound (d) to form a crosslinked structure.

The polyol compound (c) is other than the hydroxy group-containing acrylic resin (a) and the hydroxy group-containing polyester resin (b) and has two or more hydroxy groups in one molecule. The hydroxyl value of the polyol compound (c) is as high as more than 200 mg KOH/g and 1000 mg KOH/g or less. Therefore, even when added in a small amount, the crosslinking density of the clear coating composition can be improved. In addition, the molecular weight (in the case of a polymer, weight average molecular weight) of the polyol compound (c) is 100 or more and 1000 or less, which is a low molecular weight. Therefore, the viscosity of the clear coating composition is less likely to increase.

In the present embodiment, together with the hydroxy group-containing acrylic resin (a) and the hydroxy group-containing polyester resin (b), a low molecular weight, high hydroxyl value polyol compound (c) different from those resins is used. Owing to this, a clear coating composition is obtained which is highly solid but low in viscosity and is capable of forming a coating film superior in smoothness and hardness.

The hydroxyl value of the polyol compound (c) is more than 200 mg KOH/g and 1000 mg KOH/g or less. The hydroxyl value of the polyol compound (c) may be 300 mg KOH/g or more, and may be 400 mg KOH/g or more. The hydroxyl value of the polyol compound (c) may be 950 mg KOH/g or less, and may be 900 mg KOH/g or less.

The polyol compound (c) has a molecular weight of 100 or more and 1000 or less. The molecular weight of the polyol compound (c) may be 110 or more, and may be 120 or more. The molecular weight of the polyol compound (c) may be 800 or less, may be 500 or less, and may be 300 or less. In one embodiment, the molecular weight of the polyol compound (c) may be 100 or more and 800 or less.

The solid content of the polyol compound (c) accounting for in 100 parts by mass of the total solid content of the hydroxy group-containing components is, for example, 1 part by mass or more. Owing to this, the smoothness of a resulting coating film is likely to be improved. The solid content of the polyol compound (c) may be 1.5 parts by mass or more, and may be 2 parts by mass or more. The solid content of the polyol compound (c) is, for example, 10 parts by mass or less. Owing to this, the drying property of the clear coating composition is likely to be improved. The solid content of the polyol compound (c) may be 7 parts by mass or less, and may be 5 parts by mass or less. In one embodiment, the solid content of the polyol compound (c) accounting for in 100 parts by mass of the total solid content of the hydroxy group-containing components is 1 part by mass or more and 10 parts by mass or less.

The solid content ratio b/c of the hydroxy group-containing polyester resin (b) to the polyol compound (c) on a mass basis is, for example, 90/10 to 50/50. Owing to this, the physical properties of a resulting coating film are likely to be improved while increase in viscosity of the clear coating composition is inhibited. The solid content ratio b/c may be 90/10 to 60/40, and may be 90/10 to 70/30.

The solid content ratio a/(b+c) of the hydroxy group-containing acrylic resin (a) to the hydroxy group-containing polyester resin (b) and the polyol compound (c) on a mass basis is, for example, 90/10 to 60/40. Owing to this, the physical properties of a resulting coating film are likely to be improved while increase in viscosity of the clear coating composition is inhibited. The blending ratio a/(b+c) may be 90/10 to 70/30, and may be 90/10 to 75/25.

From the viewpoint of viscosity, smoothness of a coating film, and hardness, the solid content of the hydroxy group-containing acrylic resin (a) accounting for in 100 parts by mass of the total solid content of the hydroxy group-containing acrylic resin (a), the hydroxy group-containing polyester resin (b), and the polyol compound (c) may be 60 parts by mass or more and 95 parts by mass or less. Similarly, the solid content of the hydroxy group-containing polyester resin (b) may be 4 parts by mass or more and 30 parts by mass or less. Similarly, the solid content of the polyol compound (c) may be 1 part by mass or more and 10 parts by mass or less.

The solid content of the hydroxy group-containing acrylic resin (a) accounting for in 100 parts by mass of the solid content of (a)+(b)+(c) may be 65 parts by mass or more, and may be 70 parts by mass or more. The solid content of the hydroxy group-containing acrylic resin (a) accounting for in 100 parts by mass of the solid content of (a)+(b)+(c) may be 90 parts by mass or less, and may be 85 parts by mass or less. In one embodiment, the solid content of the hydroxy group-containing acrylic resin (a) accounting for in 100 parts by mass of the solid content of (a)+(b)+(c) is 60 parts by mass or more and 95 parts by mass or less.

The solid content of the hydroxy group-containing polyester resin (b) accounting for in 100 parts by mass of the solid content of (a)+(b)+(c) may be 7 parts by mass or more, and may be 10 parts by mass or more. The solid content of the hydroxy group-containing polyester resin (b) accounting for in 100 parts by mass of the solid content of (a)+(b)+(c) may be 25 parts by mass or less, and may be 20 parts by mass or less. In one embodiment, the solid content of the hydroxy group-containing polyester resin (b) accounting for in 100 parts by mass of the solid content of (a)+(b)+(c) is 4 parts by mass or more and 30 parts by mass or less.

The solid content of the polyol compound (c) accounting for in 100 parts by mass of the solid content of (a)+(b)+(c) may be 1.5 parts by mass or more, and may be 2 parts by mass or more. The solid content of the polyol compound (c) accounting for in 100 parts by mass of the solid content of (a)+(b)+(c) may be 7 parts by mass or less, and may be 5 parts by mass or less. In one embodiment, the solid content of the polyol compound (c) accounting for in 100 parts by mass of the solid content of (a)+(b)+(c) is 1 part by mass or more and 10 parts by mass or less.

The polyol compound (c) is not particularly limited as long as it is other than the hydroxy group-containing acrylic resin (a) and the hydroxy group-containing polyester resin (b) and has two or more hydroxy groups in one molecule. From the viewpoint that the physical properties (in particular, hardness and weatherability) of a resulting coating film are easily improved, the polyol compound (c) may have an alicyclic hydrocarbon group. From the same point of view, the polyol compound (c) may have two hydroxy groups.

At least one hydroxy group of the polyol compound (c) may be directly bonded to an alicyclic hydrocarbon group or bonded via a hydrocarbon group having 1 or 2 carbon atoms. The alicyclic hydrocarbon group may be either a 5-membered ring or a 6-membered ring. The alicyclic hydrocarbon group may be a 6-membered ring.

Examples of the polyol compound (c) include diol compounds such as cyclohexanediol, cyclohexanedimethanol, cyclohexanediethanol, and cyclopentanedimethanol. The arrangement of the two hydroxy groups of the diol compound is not particularly limited, and may be any of 1,1-, 1,2-, and 1,3-. From the viewpoint of hardness, the diol compound may be 1,3-cyclohexanedimethanol, in which two hydroxy groups are each bonded to cyclohexane via a methylene group.

### (Other Hydroxy Group-Containing Components)

The clear coating composition according to the present embodiment may further contain, for example, at least one resin selected from the group consisting of a polycarbonate polyol resin, a polyether polyol resin, and a polycaprolactone polyol resin as other hydroxy group-containing components.

The solid content of the other hydroxy group-containing component accounting for in 100 parts by mass of the total solid content of the hydroxy group-containing components is, for example, 20 parts by mass or less, may be 15 parts by mass or less, and may be 10 parts by mass or less.

### (d) Isocyanate Compound

The polyisocyanate compound (d) is a curing agent, and reacts with the hydroxy group-containing components to form a crosslinked structure, thereby curing a coating composition.

The polyisocyanate compound has at least two isocyanate groups in one molecule. Examples of the polyisocyanate compound include aliphatic polyisocyanates, alicyclic polyisocyanates, aliphatic polyisocyanates having an aromatic ring not bonded to an isocyanate group in the molecule (araliphatic polyisocyanates), aromatic polyisocyanates, and derivatives of these polyisocyanates. The examples specifically include aromatic polyisocyanates such as tolylene diisocyanate, 4,4′-diphenylmethane diisocyanate, xylylene diisocyanate, and metaxylylene diisocyanate; aliphatic polyisocyanates such as hexamethylene diisocyanate; alicyclic polyisocyanates such as isophorone diisocyanate; and multimers thereof such as biuret type multimers, nurate type multimers, and adduct type multimers. These are used singly or two or more of them are used in combination.

The equivalent ratio (NCO/OH) of the isocyanate groups contained in the polyisocyanate compound (d) to the hydroxy groups contained in the hydroxy group-containing components may be 0.7 or more, and may be 0.8 or more. The equivalent ratio (NCO/OH) may be 2.0 or less, may be 1.8 or less, and may be 1.5 or less. In one embodiment, the equivalent ratio (NCO/OH) is 0.7 or more and 2.0 or less. When the equivalent ratio (NCO/OH) is in this range, a clear coating film having superior hardness and weatherability is likely to be formed.

### (Other Curing Agents)

The clear coating composition according to the present embodiment may further contain, for example, at least one selected from the group consisting of an amino resin, an epoxy compound, an aziridine compound, a carbodiimide compound, and an oxazoline compound as other curing agents. The content of the other curing agent is appropriately set according to the coating film forming components.

### (e) Organic Dispersive Particles

The organic dispersive particles (e) contribute to viscosity control and improvement in pot life of a clear coating composition, and improvement in hardness of a coating film. Since organic dispersive particles (e) can be dispersed uniformly in a particulate form even in a clear coating composition that has been made highly solid, interaction hardly works between the particles, and the organic dispersive particles (e) do not significantly increase the viscosity of the clear coating composition.

On the other hand, when the clear coating composition is applied and the solid component concentration further increases, the interaction acting between organic dispersive particles (e) increases. Therefore, the organic dispersive particles (e) function as a viscosity control agent, and appearance abnormality such as sagging is thereby reduced. At this time, the organic dispersive particles (e) also strongly interact with the hydroxy group-containing components. Therefore, a coating film having high hardness is quickly formed from the clear coating composition. This coating film sufficiently satisfies, for example, the performance required for automobile components.

In a clear coating composition that has been made highly solid, the reactivity between the hydroxy group-containing components and the isocyanate compound is likely to enhanced. Since the organic dispersive particles (e) are dispersed in the clear coating composition as described above, the organic dispersive particles (e) easily enter between the hydroxy group-containing components and the isocyanate compound, and can hold them separated from each other. As a result, the pot life of the clear coating composition can be improved. By these actions, the organic dispersive particles (e) greatly contribute to making the coating material highly solid.

The particle size of the organic dispersive particles (e) is not particularly limited. The average particle size of the organic dispersive particles (e) in the clear coating composition may be 15 nm or more, and may be 20 nm or more. The average particle size of the crosslinked dispersive particles (el) may be 5000 nm or less, may be 1000 nm or less, and may be 500 nm or less. In one embodiment, the average particle size of the organic dispersive particles (e) is 10 nm or more and 5000 nm or less. The average particle size of the organic dispersive particles (e) is a 50% average particle size (D50) of primary particles in a number-based particle size distribution determined using a laser diffraction/scattering type particle size distribution analyzer.

The blending amount of the organic dispersive particles (e) based on 100 parts by mass of the total solid content of the hydroxy group-containing components is, for example, 0.1 parts by mass or more. Owing to this, improvement of the clear coating composition in pot life can be expected. The blending amount of the organic dispersive particles (e) may be 0.5 parts by mass or more, and may be 1 part by mass or more. The blending amount of the organic dispersive particles (e) is, for example, 10 parts by mass or less. Owing to this, an increase in the coating viscosity of the clear coating composition is likely to be inhibited. The blending amount of the organic dispersive particles (e) may be 7 parts by mass or less, and may be 5 parts by mass or less. In one embodiment, the blending amount of the organic dispersive particles (e) based on 100 parts by mass of the total solid content of the hydroxy group-containing components is 0.1 parts by mass or more and 10 parts by mass or less.

The organic dispersive particles (e) are not particularly limited as long as they are formed of an organic compound and insoluble in the clear coating composition. Examples of the organic dispersive particles include organic compounds having a crosslinked structure in the molecule (crosslinked dispersive particles (e1)), and core-shell type organic compounds (core-shell dispersive particles (e2)), NAD (nonaqueous dispersive particles).

The crosslinked dispersive particles (e1) are, for example, made of (meth)acrylic resin. “(Meth)acryl” is a concept including both acryl and methacryl.

The crosslinked dispersive particles (e1) are prepared, for example, as follows.

First, an ethylenically unsaturated monomer (e11) and a crosslinkable monomer (e12) are emulsion polymerized in an aqueous solvent by a known method to afford an emulsion containing polymer-crosslinked fine particles. Thereafter, water contained in the emulsion is removed. As a result, crosslinked dispersive particles (e1) are obtained. The removal of the water is carried out, for example, by replacement of an aqueous solvent with an organic solvent, azeotropic distillation, centrifugation, filtration, and drying. In the case of replacing an aqueous solvent with an organic solvent, the crosslinked dispersive particles (e1) are obtained with the particles being dispersed in the organic solvent.

Typical examples of the ethylenically unsaturated monomer (e11) include alkyl esters of (meth)acrylic acid. Examples of the alkyl ester of (meth)acrylic acid include methyl(meth)acrylate, ethyl(meth)acrylate, n-butyl (meth)acrylate, isobutyl (meth)acrylate, and 2-ethylhexyl (meth)acrylate. These are used singly or two or more of them are used in combination.

As the ethylenically unsaturated monomer (e11), together with the alkyl ester of acrylic acid or methacrylic acid, another monomer having an ethylenically unsaturated bond that can be copolymerized therewith may be used. Examples of the other monomer include styrene, a-methylstyrene, vinyltoluene, t-butylstyrene, ethylene, propylene, vinyl acetate, vinyl propionate, acrylonitrile, methacrylonitrile, and dimethylaminoethyl (meth) acrylate. These are used singly or two or more of them are used in combination.

Examples of the crosslinkable monomer (e12) typically include a monomer (e12a) having two or more radically polymerizable ethylenically unsaturated bonds in one molecule and a combination (e12b) of two kinds of ethylenically unsaturated group-containing monomers each having a group capable of reacting with each other. The monomer (e12a) and the combination (e12b) of monomers are used each alone or in combination.

Examples of the monomer (e12a) include a polymerizable unsaturated monocarboxylic acid ester of a polyhydric alcohol, a polymerizable unsaturated alcohol ester of a polybasic acid, and an aromatic compound having two or more vinyl groups.

As a starting monomer of the crosslinked dispersive particles (e1), a monomer (e13) having a functional group capable of reacting with a crosslinking agent may be further used. Examples of the monomer (e13) typically include a carboxyl group-containing monomer, a hydroxyl group-containing monomer, and a nitrogen-containing monomer.

The core-shell dispersive particles (e2) are, for example, formed of (meth)acrylic resin.

In the core-shell dispersive particles (e2), the core part contains, for example, an acrylic acid ester monomer (e21) having a hydroxy group or an α,β-ethylenically unsaturated monomer (e22a) having a carboxyl group and an α,β-ethylenically unsaturated monomer (e22b) having a hydroxy group. The hydroxyl value of the core part is, for example, 100 mg KOH/g or more and 200 mg KOH/g or less.

Examples of the acrylic acid ester monomer (e21) containing a hydroxy group include 4-hydroxybutyl acrylate (4HBA) and CH₂═C(R)COO(CH₂)₂O[CO(CH₂)ₘO]ₙH, wherein R is hydrogen or a lower alkyl group having 6 or less carbon atoms, and m and n are natural numbers with which the number of the carbon atoms of the “(CH₂)₂O[CO(CH₂)ₘO]ₙ” moiety is 4 or more and 12 or less.

Examples of the α,β-ethylenically unsaturated monomer (e22a) having a carboxyl group include acrylic acid and methacrylic acid. Examples of the α,β-ethylenically unsaturated monomer (e22b) having a hydroxy group include acrylic acid hydroxy esters such as 2-hydroxyethyl acrylate; and methacrylic acid hydroxy esters such as 2-hydroxyethyl methacrylate.

The core part may further contain acrylic acid; an acrylic acid ester such as methyl acrylate; methacrylic acid; a methacrylic acid ester such as methyl methacrylate; a monomer having one or two vinyl groups; a monomer having an isocyanate group; a monomer having an allyl group; a monomer having an epoxy group; or an acid anhydride having one or two vinyl groups.

In the organic dispersive particles (e), the shell part contains, for example, a hydroxy group-containing acrylic resin (polymer). The hydroxyl value of the shell part is, for example, 50 mg KOH/g or more and 160 mg KOH/g or less.

Examples of the starting monomer of the shell part include acrylic acid hydroxy esters such as 2-hydroxyethyl acrylate and 4-hydroxybutyl acrylate; and methacrylic acid hydroxy esters such as 2-hydroxyethyl methacrylate and 4-hydroxybutyl methacrylate. Examples of the starting monomer of the shell part may further include acrylic acid; acrylic acid esters such as methyl acrylate, butyl acrylate, isobutyl acrylate, t-butyl acrylate, 2-ethylhexyl acrylate, lauryl acrylate, and isoboronyl acrylate; methacrylic acid; methacrylic acid esters such as methyl methacrylate, butyl methacrylate, isobutyl methacrylate, t-butyl methacrylate, 2-ethylhexyl methacrylate, lauryl methacrylate, and isoboronyl methacrylate; and ethylenically unsaturated monomers having an aromatic ring such as styrene.

The core-shell dispersive particles (e2) can be produced, for example, by polymerizing the constituent material (polymer) of the shell part and the constituent material (monomer) of the core part in a solvent that dissolves the monomer but does not dissolve the polymer.

### (f) Cellulose Derivative

The cellulose derivative (f) inhibits tack of a coating film. Even when the clear coating composition is cured at a low temperature (for example, 100° C. or lower) in a short time (for example, 60 minutes or less) with the cellulose derivative (f), the resulting coating film has a low tack. The cellulose derivative (f) may further function as a viscosity control agent.

The number average molecular weight of the cellulose derivative (f) is, for example, 10000 or more. Owing to this, tack of a surface of a coating film is more likely to be inhibited. The number average molecular weight of the cellulose derivative (f) may be 12000 or more, and may be 13000 or more. The number average molecular weight of the cellulose derivative (f) is, for example, 40000 or less. Owing to this, increase in viscosity of the clear coating composition is further inhibited. The number average molecular weight of the cellulose derivative (f) may be 30000 or less, and may be 25000 or less. In one embodiment, the number average molecular weight of the cellulose derivative (f) is 10000 or more and 40000 or less.

The Tg of the cellulose derivative (f) is, for example, 80° C. or higher. Owing to this, tackiness can be improved. The Tg of the cellulose derivative (f) may be 82° C. or higher, and may be 85° C. or higher. The Tg of the cellulose derivative (f) is, for example, 160° C. or lower. Owing to this, the viscosity of the clear coating composition can be properly maintained. The Tg of the cellulose derivative (f) may be 150° C. or lower, and may be 130° C. or lower. In one embodiment, the Tg of the cellulose derivative (f) is 80° C. or higher and 160° C. or lower.

From the viewpoint of viscosity, the cellulose derivative (f) may have a number average molecular weight of 10000 or more and 40000 or less and a glass transition temperature Tg of 80° C. or higher.

The cellulose derivative (f) is not particularly limited. Examples of the cellulose derivative (f) typically include cellulose ethers and cellulose esters. The cellulose derivative (f) includes at least one selected from the group consisting of a cellulose ether and a cellulose ester.

Examples of the cellulose ester specifically include nitrocellulose, cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethyl cellulose acetate, carboxymethyl cellulose acetate propionate, carboxymethyl cellulose acetate butyrate, cellulose acetate butyrate succinate, and cellulose propionate butyrate. These are used singly or two or more of them are used in combination. Among them, carboxymethylcellulose acetate butyrate (CAB) is preferable from the viewpoint of solubility with resin components, expression of viscosity, and so on.

Examples of the cellulose ether include carboxymethyl cellulose, methyl cellulose, hydroxyethyl cellulose, hydroxyethyl methyl cellulose, and hydroxypropyl methyl cellulose.

The blending amount of the cellulose derivative (f) based on 100 parts by mass of the total solid content of the hydroxy group-containing components is, for example, 0.1 parts by mass or more. Owing to this, tack of a surface of a resulting coating film is likely to be inhibited. The blending amount of the cellulose derivative (f) may be 0.2 parts by mass or more, and may be 0.5 parts by mass or more. The blending amount of the cellulose derivative (f) may be 10 parts by mass or less. Owing to this, increase in viscosity is likely to be inhibited. The blending amount of the cellulose derivative (f) may be 7 parts by mass or less, and may be 5 parts by mass or less. In one embodiment, the blending amount of the cellulose derivative (f) based on 100 parts by mass of the total solid content of the hydroxy group-containing components is 0.1 parts by mass or more and 10 parts by mass or less.

### (Other Viscosity Control Agents)

The clear coating composition according to the present embodiment may contain another viscosity control agent other than the organic dispersive particles (e) and the cellulose derivative (f). The other viscosity control agent may be used as long as the effect of the present invention is not impaired. The blending amount of the other viscosity control agent based on 100 parts by mass of the total solid content of the hydroxy group-containing components may be 10 parts by mass or less, may be 7 parts by mass or less, and may be 5 parts by mass or less.

Examples of the other viscosity control agent include inorganic viscosity agents, urethane associative viscosity agents, polycarboxylic acid type viscosity agents, and amide-based viscosity agents. These are used singly or two or more of them are used in combination. Examples of the inorganic viscosity agent include layered silicates (silicate minerals), halogenated minerals, oxidized minerals, carbonate minerals, borate minerals, sulfate minerals, molybdate minerals, tungstate minerals, phosphate minerals, arsenate minerals, and vanadate minerals. Examples of the urethane associative viscosity agent includes a polyurethane-based viscosity agent having a hydrophobic chain in the molecule and a urethane-urea-based viscosity agent in which at least a part of the main chain is a hydrophobic urethane chain.

### (g) Diluent Component

The clear coating composition according to the present embodiment may contain a diluent component (g). The clear coating composition is appropriately diluted with a diluent component in consideration of a coating method, a coating environment such as temperature and humidity, and so on. Examples of the diluent component include water and a nonaqueous solvent. The clear coating composition according to the present embodiment may also contain the nonaqueous solvent or the like used in the production of each ingredient.

Examples of the nonaqueous solvent include aliphatic or alicyclic hydrocarbon solvents such as cyclohexane, methylcyclohexane, cycloheptane, methylcycloheptane, and mineral split; ketone-based organic solvents such as acetone, acetylacetone, methyl ethyl ketone, methyl i-butyl ketone, methyl amyl ketone, and cyclohexanone; aromatic hydrocarbon-based organic solvents such as benzene, toluene, ethylbenzene, propylbenzene, t-butylbenzene, o-xylene, m-xylene, p-xylene, tetralin, and decalin; ester-based organic solvents such as methyl acetate, ethyl acetate, n-butyl acetate, and aluminum acetate; cellosolve-based organic solvents such as methyl cellosolve, ethyl cellosolve, n-propyl cellosolve, i-propyl cellosolve, n-butyl cellosolve, i-butyl cellosolve, i-amyl cellosolve, phenyl cellosolve, and benzyl cellosolve; carbitol-based organic solvents such as methyl carbitol, ethyl carbitol, n-propyl carbitol, i-propyl carbitol, n-butyl carbitol, i-butyl carbitol, i-amyl carbitol, carbitol acetate, phenyl carbitol, and benzyl carbitol; ether-based organic solvents such as ethylene glycol monoisopropyl ether, ethylene glycol monoethyl ether, ethylene glycol mono-n-propyl ether, ethylene glycol mono-n-butyl ether, ethylene glycol mono-t-butyl ether, propylene glycol monomethyl ether, propylene glycol monoethyl ether, propylene glycol mono-n-propyl ether, propylene glycol mono-n-butyl ether, propylene glycol monomethyl ether acetate, propylene glycol monoethyl ether acetate, and dioxane. These are used singly or two or more of them are used in combination.

### (Other Additives)

The clear coating composition according to the present embodiment may further contain additives commonly used in the coating material field. For example, a coloring pigment and/or a luster pigment may be contained as long as the transparency is not impaired. Furthermore, an ultraviolet absorber, a hindered amine light stabilizer, an antioxidant, crosslinked resin particles, a surface conditioning agent, a catalyst, or the like may be contained.

### [Clear Coating Film]

A clear coating film can be formed using the clear coating composition according to the present embodiment. The resulting clear coating film is good in both smoothness and physical properties.

The thickness of the clear coating film is not particularly limited. From the viewpoint of scratch resistance and smoothness, the thickness of the clear coating film after drying is, for example, 15 μm or more, and may be 20 μm or more. The thickness of the clear coating film may be 60 μm or less, and may be 40 μm or less. The thickness of the clear coating film can be measured with an electromagnetic coating thickness meter (for example, SDM-miniR manufactured by SANKO). The thickness of the clear coating film is an average value of the thicknesses of the clear coating film at arbitrary five points. The thicknesses of other coating films are also measured and calculated in the same manner.

The clear coating film has high hardness. The hardness of the clear coating film measured in accordance with JIS K 5600-5-4 Scratch hardness (Pencil method) is, for example, B or more.

The clear coating film has superior smoothness. The amount of reflected light (LW₀) in a long wavelength region (1200 μm to 12000 μm) measured by a surface reflectance measuring device (for example, Wave Scan-dual manufactured by BYK) may be 20 or less. In the Wave Scan-dual, the clear coating film is irradiated with laser light at an angle of 60° while the light source is moved, and the reflected light is measured. The reflected light measured is classified by wavelength. The smaller the LW₀ is, the smoother the surface is. The LW₀ is a numerical value measured for a clear coating film formed from a clear coating composition immediately after the preparation thereof.

Since the clear coating composition according to the present embodiment has a long pot life, for example, a clear coating film formed using a clear coating composition with a lapse of 4 hours from the preparation thereof is also smooth. The difference between the LW₀ described above and the LW₁ of the clear coating film formed using the clear coating composition with a lapse of 4 hours from the preparation thereof: LW₁−LW₀ is, for example, 10 or less, may be 5 or less, and may be 1 or less.

### [Method for Forming Clear Coating Film]

The clear coating film is formed by applying the clear coating composition to an article to be coated and then curing the composition. The clear coating composition can be cured by heating. The applying method and the curing conditions will be described later.

### [Coated Article]

A clear coating film is usually disposed on the outermost side to cover one or more other coating films formed on an article to be coated. A coated article with a clear coating film includes, for example, an article to be coated, a colored coating film formed on the article to be coated, and the clear coating film formed on the colored coating film. The clear coating film is formed from the clear coating composition according to the present embodiment.

### (Article to be Coated)

The material of the article to be coated is not particularly limited. Examples of the material of the article to be coated include metal, resin, and glass. The shape of the article to be coated is also not particularly limited. Examples of the article to be coated specifically include automobile bodies such as passenger cars, trucks, motorcycles, and buses, parts for automobile bodies, and automobile parts such as spoilers, bumpers, mirror covers, grilles, and door knobs.

Examples of the metal include iron, copper, aluminum, tin, zinc, and alloys thereof (e.g., steel). Examples of a usable metallic article to be coated typically include steel sheets such as cold-rolled steel sheets, hot-rolled steel sheets, stainless steels, electrogalvanized steel sheets, hot-dip galvanized steel sheets, zinc-aluminum alloy-based plated steel sheets, zinc-iron alloy-based plated steel sheets, zinc-magnesium alloy-based plated steel sheets, zinc-aluminum-magnesium alloy-based plated steel sheets, aluminum-based plated steel sheets, aluminum-silicon alloy-based steel sheets, and tin-based plated steel sheets.

The metallic article to be coated may have been subjected to surface treatment. Examples of the surface treatment include phosphate salt treatment, chromate treatment, zirconium chemical conversion treatment, and composite oxide treatment. The metallic article to be coated may have been further coated with an electrodeposition coating material after the surface treatment. The electrodeposition coating material may be of a cationic type or of an anionic type.

Examples of the resin include polypropylene resin, polycarbonate resin, urethane resin, polyester resin, polystyrene resin, ABS resin, vinyl chloride resin, and polyamide resin.

The resin article to be coated preferably has been subjected to degreasing treatment.

### (Colored Coating Film)

The colored coating film may be a single layer or a laminated coating film having two or more layers. The colored coating film may be a so-called primer coating film having one layer or two or more layers, may be a so-called base coating film having one layer or two or more layers, and may be a combination thereof.

### <Base Coating Film>

The base coating film is formed of, for example, a base coating composition including a coating film forming component, a curing agent, a viscosity control agent, a diluent component, and a pigment. The base coating composition may contain the various additives described above, as necessary. The components contained in the respective base coating films may be either the same or different. The base coating composition may be either solvent-based or water-borne. Examples of the coating film forming component, the curing agent, the viscosity control agent, and the diluent component to be blended in the base coating composition include the components disclosed as examples of those to be blended in the clear coating composition.

The viscosity of the base coating composition measured with a B-type viscometer at 20° C. is, for example, 500 cps/6 rpm or more and 6000 cps/6 rpm or less. The solid component ratio of the base coating composition is, for example, 30% by mass or more and 70% by mass or less. The solid component of the base coating composition refers to all components of the base coating composition excluding the diluent component.

The thickness of the base coating film is not particularly limited, and is appropriately set according to the purpose. The thickness per layer of the base coating film is, for example, 10 μm or more, may be 15 μm or more, and may be 20 μm or more. The thickness per layer of the base coating film is, for example, 50 μm or less, may be 45 μm or less, and may be 40 μm or less.

Examples of the pigment include coloring pigments, luster pigments, and extender pigments.

Examples of the coloring pigment include organic coloring pigments such as azo chelate pigments, insoluble azo pigments, condensed azo pigments, diketopyrrolopyrrole-based pigments, benzimidazolone-based pigments, phthalocyanine-based pigments, indigo pigments, perinone-based pigments, perylene-based pigments, dioxane-based pigments, quinacridone-based pigments, isoindolinone-based pigments, and metal complex pigments; and inorganic coloring pigments such as chrome yellow, yellow iron oxide, red iron oxide, carbon black, and titanium dioxide. These are used singly or two or more of them are used in combination.

Examples of the luster pigment include metal flakes (aluminum, chromium, gold, silver, copper, brass, titanium, nickel, nickel chromium, stainless steel, and the like), metal oxide flakes, pearl pigments, glass flakes coated with metal or metal oxide, silica flakes coated with metal oxide, graphite, hologram pigments, and cholesteric liquid crystal polymers. These are used singly or two or more of them are used in combination.

Examples of the extender pigment include calcium carbonate, barium sulfate, clay, and talc. These are used singly or two or more of them are used in combination.

The total concentration of all pigments, that is, the mass ratio (PWC) of all the pigments to 100% by mass of the resin solid content of the base coating composition is preferably 0.1% by mass or more and 50% by mass or less. Owing to this, the smoothness of a resulting coating film is improved. The PWC of each pigment is not particularly limited. The PWC of the luster pigment may be, for example, 1% by mass or more and 40% by mass or less. The PWC of the luster pigment is preferably 5% by mass or more. The PWC of the luster pigment is preferably 30% by mass or less.

### <Primer Coating Film>

The primer coating film is interposed between the article to be coated and the base coating film. The primer coating film improves adhesion between the base coating film and the article to be coated (in particular, article made of resin). When the surface of the article to be coated is not uniform, a uniform coating surface is formed by primer coating, and unevenness of the base coating film is easily inhibited.

The primer coating film is formed of, for example, a primer coating composition including a coating film forming component, a material adhering component, a viscosity control agent, a diluent component, a pigment, and, as necessary, a curing agent. The primer coating composition may contain various additives, as necessary. The primer coating composition may be either solvent-based or water-borne. Examples of the coating film forming component, the curing agent, the viscosity control agent, the diluent component, and the pigment include the respective components recited as examples of those to be blended in the base coating composition. For example, the viscosity of a water-borne primer coating composition measured with a B-type viscometer at 20° C. is 500 cps/6 rpm or more and 6000 cps/6 rpm or less. The solid component content of the primer coating composition is, for example, 30% by mass or more and 50% by mass or less. The solid component of the primer coating composition refers to all components of the primer coating composition excluding the diluent component.

The thickness of the primer coating film is not particularly limited. From the viewpoint of the smoothness and chipping resistance of a coated article, the thickness of the primer coating film may be 5 μm or more and 40 μm or less. The thickness of the primer coating film may be 7 μm or more. The thickness of the primer coating film may be 25 μm or less.

### [Method for Producing Coated Article]

The coated article is produced by a method including a step of applying a colored coating composition to an article to be coated to form an uncured colored coating film, a step of curing the uncured colored coating film, a step of applying a clear coating composition to the colored coating film to form an uncured clear coating film, and a step of curing the uncured clear coating film.

When the clear coating film is formed, the colored coating film may be either cured or uncured. From the viewpoint of productivity, adhesion, and water resistance, it is preferable that coating films are formed in layers without being cured (so-called wet-on-wet application), and then the plurality of uncured coating films are simultaneously cured. Specifically, it is preferable that the coated article is produced by a method including a step of applying a colored coating composition to an article to be coated to form an uncured colored coating film, a step of a step of applying a clear coating composition to the uncured colored coating film to form an uncured clear coating film, and a step of curing the uncured colored coating film and the uncured clear coating film.

Hereinafter, each of the steps will be described by taking as an example a method of forming a base coating film as the colored coating film. However, the method for producing the coated article according to the present embodiment is not limited thereto. As the colored coating film, a primer coating film and a base coating film may be formed. The primer coating film can be formed in the same manner as the base coating film.

### (I) Step of Forming Uncured Base Coating Film

The uncured base coating film is formed by applying the base coating composition described above to an article to be coated. The base coating composition is applied, for example, such that the thickness of the base coating film after curing is 10 μm or more and 50 μm or less.

The applying method is not particularly limited. Examples of the applying method include air spray coating, airless spray coating, and rotary atomization coating. These methods may be combined with electrostatic coating. Among them, rotary atomization type electrostatic coating is preferable from the viewpoint of coating efficiency. For the rotary atomization type electrostatic coating, for example, a rotary atomization type electrostatic coating machine commonly called “micro micro bell (μμ bell)”, “micro bell (μ bell)”, “metallic bell”, or the like is used.

After the base coating composition is applied, preliminary drying (also referred to as preheating) may be carried out. As a result, the diluent component contained in the base coating composition is inhibited from bumping in the curing step, so that the occurrence of bubbles is easily controlled. Further, the preliminary drying inhibits the mixing of the uncured base coating film and a coating composition to be applied thereto, so that a mixed phase is hardly formed. Therefore, the smoothness of a resulting coated article is likely to be improved.

Conditions for the preliminary drying are not particularly limited. Examples of the preliminary drying include a method in which the item to be dried is left standing for 5 minutes or more and 15 minutes or less under a room temperature condition, and a method in which the item to be dried is heated for 30 seconds or more and 5 minutes or less under a temperature condition of 50° C. or higher and 80° C. or lower.

### (II) Step of Forming Uncured Clear Coating Film

The uncured clear coating film is formed by applying the clear coating composition described above to the colored coating film. The clear coating composition is applied, for example, such that the thickness of the clear coating film after curing is 15 μm or more and 60 μm or less.

The applying method is not particularly limited. Examples of the applying method include the same methods as the methods of applying the base coating composition. Among them, rotary atomization type electrostatic coating is preferable from the viewpoint of coating efficiency. After applying the clear coating composition, preliminary drying may be carried out. The conditions for the preliminary drying are not particularly limited, and may be the same as those for the preliminary drying of the base coating film.

### (III) Curing Step

The respective uncured coating films are cured. Each coating film can be cured by heating. In this step, the base coating film and the clear coating film may be cured at once.

Heating conditions are appropriately set according to the compositions of the respective coating compositions, the material of the article to be coated, and so on. The heating temperature is, for example, 60° C. or higher and 120° C. or lower, and may be 65° C. or higher and 90° C. or lower. When the clear coating composition according to the present embodiment is used, a clear coating film having high hardness is formed even at such a low temperature.

The heating time may be appropriately set according to the heating temperature. When the heating temperature is 60° C. or higher and 120° C. or lower, the heating time is, for example, 10 minutes or more and 60 minutes or less, and may be 15 minutes or more and 45 minutes or less. The heating time means a time during which the temperature in a heating device is maintained at a target temperature, and the time taken until the temperature reaches the target temperature is not considered. Examples of the heating device include a drying furnace using a heating source such as hot air, electricity, gas, or infrared rays.

### EXAMPLES

Hereinafter, the present invention will be described by way of examples. The present invention is not limited to the examples described below.

### Examples 1 to 8, Comparative Examples 1 to 8

The components were mixed in accordance with the components and blending amounts shown in Table 1. Each of the clear coating compositions obtained had a solid component concentration of 58% by mass.

The components used in the examples and the comparative examples are as follows. The hydroxy group-containing acrylic resin (a) was produced as follows.

### Production of Hydroxy Group-Containing Acrylic Resin A

A reactor equipped with a stirring blade, a thermometer, a dropping device, a temperature controller, a nitrogen gas inlet, and a cooling tube was charged with 57 parts of butyl acetate, and the temperature was raised to 120° C. with stirring while nitrogen gas was introduced. A mixture of 0.8 parts of methacrylic acid, 26.8 parts of 2-ethylhexyl acrylate, 33.0 parts of methyl methacrylate, and 39.4 parts of 2-hydroxyethyl methacrylate and a solution prepared by dissolving 10 parts of t-butyl peroxy-2-ethylhexanate in 5 parts of butyl acetate were added dropwise to that reactor over 3 hours. After completion of the dropwise addition, the mixture was aged for 1 hour. Thereafter, a solution prepared by dissolving 0.2 parts of t-butyl peroxy-2-ethylhexanate in 5 parts of butyl acetate was further added dropwise to that reactor over 1 hour. The mixture was aged for 2 hours with the inside of the reactor being maintained at 120° C., and the reaction was thereby completed, affording a hydroxy group-containing acrylic resin. The resulting hydroxy group-containing acrylic resin had a nonvolatile content of 60%, a weight average molecular weight of 4500, and a glass transition temperature of 20° C. The hydroxyl value (OHV) was calculated to be 170 from the monomer formulation.

### [Production of Hydroxy Group-Containing Acrylic Resins B to F]

Hydroxy group-containing acrylic resins B to F were produced in the same manner as in the case of the hydroxy group-containing acrylic resin A except that the kind and amount of the monomers and the amount of the polymerization initiator (t-butyl peroxy-2-ethylhexanate) were changed as shown in Table 1.

TABLE 1

| | | Hydroxy group-containing acrylic resin | | | | | |
|---|---|---|---|---|---|---|---|
| | | A | B | C | D | E | F |
| Starting | Methacrylic acid | 0.8 | 0.80 | 0.80 | 0.80 | 0.80 | 0.8 |
| material | 2-Ethylhexyl acrylate | 26.8 | 18.10 | 28.48 | 1.27 | 32.95 | 26.8 |
| | Methyl methacrylate | 33 | 46.30 | 40.56 | 77.05 | 31.45 | 33 |
| | 2-Hydroxyethyl methacrylate | 39.4 | 34.80 | 30.16 | 20.88 | 34.80 | 39.4 |
| | Polymerization initiator | 10 | 10 | 10 | 10 | 7 | 20 |
| | Polymerization initiator (additional) | 0.2 | 0.2 | 0.2 | 0.2 | 0.2 | 2 |

| | | | | | | | |
|---|---|---|---|---|---|---|---|
| Weight average molecular weight | | 4500 | 4500 | 4700 | 4300 | 6500 | 2900 |
| OHV | mg KOH/g | 170 | 150 | 130 | 90 | 150 | 170 |
| AV | mg KOH/g | 3 | 3 | 3 | 3 | 3 | 3 |
| Tg | ° C. | 20 | 40 | 20 | 90 | 10 | 20 |
| Nonvolatile content | | 60% | 60% | 59% | 60% | 61% | 56% |

### (b) Hydroxy Group-Containing Polyester Resin

Trade name: Basonol HPE1170B, manufactured by BASF SE, hydroxyl value: 280 mg KOH/g, weight average molecular weight: 1800

### (c) Polyol Compound

A: Cyclohexanedimethanol, hydroxyl value: 780 mg KOH/g, molecular weight: 144

B: Cyclohexanediethanol, hydroxyl value: 652 mg KOH/g, molecular weight: 172

C: Polypropylene glycol diol type 2000, manufactured by Wako Pure Chemical Industries, Ltd., hydroxyl value: 56 mg KOH/g, molecular weight: 2000

D: Polycarbonate diol, DURANOL T-5650J, manufactured by Asahi Kasei Corporation, hydroxyl value: 140 mg KOH/g, molecular weight: 800

### (d) Polyisocyanate Compound

Trade name: N3300, manufactured by Covestro, isocyanurate of hexamethylene diisocyanate

### (e) Organic Dispersive Particles

A: Trade name: Setalux 10-6266, manufactured by Allnex, average particle size: 65 nm, crosslinked dispersive particles

B: Trade name: AZS-797, manufactured by Nippon Paint Co., Ltd., average particle size: 94 nm, crosslinked dispersive particles

### (f) Cellulose Derivative

Trade name: Eastman CAB 551-0.01, manufactured by Eastman Chemical Company, carboxymethylcellulose acetate butyrate (CAB), number average molecular weight: 16000, Tg: 85° C.

### (g) Diluent Component

n-Butyl acetate

### (Other Viscosity Control Agents)

Trade name: DISPARLON 6900, manufactured by Kusumoto Chemicals, Ltd., amide-based viscosity agent

### [Evaluation]

The clear coating compositions prepared in Examples and Comparative Examples or test pieces (coated articles) coated with these clear coating compositions were evaluated as follows. The results of the evaluations are shown in Table 1. The method for preparing the test pieces is as follows.

### (Preparation of Test Piece)

An ABS resin substrate was prepared as an article to be coated, and wiped with isopropyl alcohol. Then, this substrate was coated with a high solids base coating material R-3417 #1J7 (silver) manufactured by Nippon Paint Automotive Coatings Co., Ltd. with a spray gun (manufactured by ANEST IWATA Corporation; W-101-134G) such that the dry film thickness was 15 μm. Thereafter, drying was performed for 3 minutes in an environment of a temperature of 20±5° C. and a relative humidity of 78% or less, and thus an uncured base coating film was formed on the ABS substrate.

Subsequently, a clear coating composition immediately after preparation was applied to the base coating film with a spray gun (manufactured by ANEST IWATA Corporation; W-101-134G) such that the dry film thickness was 30 μm. Thereafter, the substrate was left standing for 10 minutes in an environment of a temperature of 20±5° C. and a relative humidity of 78% or less, and thus an uncured clear coating film was formed. Then, the substrate having the multilayer coating film was heated at 80° C. for 15 minutes by using a dryer, affording a test piece having a cured base coating film and a cured clear coating film.

### (Coating Viscosity η₀)

The viscosity of a clear coating composition immediately after preparation was measured at 23° C. using a No. 4 Ford cup in accordance with “3. Flow Cup Method” of JIS K 5600-2-2: 1999. The average value of the viscosities of five different clear coating compositions having the same configuration was taken as the coating viscosity η₀. The coating viscosity no was evaluated according to the following criteria.

Good: The coating viscosity η₀ is 18 seconds or more and 28 seconds or less.

Poor: The coating viscosity η₀ is more than 28 seconds.

### (Smoothness A)

The smoothness A of a test piece was evaluated with a surface analyzer (Wave Scan-dual manufactured by BYK). Evaluation criteria are as follows.

Good: LW₀ is 20 or less.

Poor: LW₀ is more than 20.

### (Smoothness B)

The smoothness B of a test piece prepared in the same manner as described above except that a clear coating composition with a lapse of 4 hours from preparation was used was measured and evaluated in the same manner as in the smoothness A.

Good: LW₁ is 20 or less.

Poor: LW₁ is more than 20.

### (Hardness)

The hardness of a test piece was measured in accordance with JIS K 5600-5-4 Scratch Hardness (Pencil Method). The measured value was evaluated according to the following criteria.

Good: The measured value is “B” or more.

Poor: The measured value is “2B” or less.

### (Initial Adhesion)

A single-blade cutting tool defined in JIS K 5600-5-6 was vertically brought into contact with the coated surface of a test piece, and a cut (parallel line 1) reaching the base material (substrate) was made. Further, ten cuts each parallel to the parallel line 1 were made at equal intervals. Eleven cuts (parallel lines 2) were made at equal intervals, the cuts perpendicularly intersecting the eleven parallel lines 1 and reaching the base material. The interval between the parallel lines 1 and the interval between the parallel lines 2 were each 2 mm. In this way, a grid part including 100 squares each surrounded by four straight lines was formed.

A transparent pressure-sensitive adhesive tape defined by JIS K 5600-5-6 was closely attached to the grid part such that air bubbles were not contained between the tape and the coated surface. Thereafter, the tape was peeled off at once in a period of 0.5 seconds to 1.0 seconds, and the peeling state of the grid part was visually evaluated. Evaluation criteria are as follows.

Good: Peeling of the coating film is not observed at all.

Poor: Peeling of the coating film is observed.

### (Water Resistance)

A test piece was immersed for 240 hours in a water tank maintained at 40° C. Thereafter, the test piece was lifted from the water and dried at normal temperature for 1 hour. Subsequently, a grid part was formed on the test piece in the same manner as described above, and a peeling test and evaluation were performed.

### (Tack of Surface)

Under an atmosphere of 23° C., the surface of the coating film of a test piece was pressed with a finger, and the presence or absence of tackiness (surface tack) was evaluated. Evaluation criteria are as follows.

Good: Tackiness was not felt.

Poor: Tackiness was felt.

### (Weatherability)

Test pieces were subjected to an accelerated weatherability test for 1200 hours in accordance with JIS B 7753 using a Sunshine Weather Meter S80 (sunshine carbon arc accelerated weathering tester, manufactured by Suga Test Instruments Co., Ltd.). Furthermore, the appearance of the test piece after this test was visually observed, the color difference (ΔE) between before and after the test was measured, and a 60° gloss value was measured. The 60° gloss value was measured with a gloss meter GN-268 Plus (manufactured by Konica Minolta, Inc.). These four items were evaluated according to the following criteria.

Good: No peeling of the coating film was observed, no significant abnormality was observed visually, the color difference (ΔE) was 3.0 or less, and the 60° gloss value was 80 or more.

Fair: One of the above four items is not satisfied.

Poor: Two or more of the above four items are not satisfied.

### (Pot Life)

A clear coating composition was prepared in a 500 mL plastic cup under conditions of 23° C. and 50% RH. The viscosity of the clear coating composition immediately after the preparation and the viscosity thereof after leaving at rest for 4 hours under the conditions of 23° C. and 50% RH were measured by the method described above. The difference was evaluated according to the following criteria.

Good: The viscosity change is within 5 seconds.

Poor: The viscosity change is more than 5 seconds.

TABLE 2

| | | | | OHV | Tg | Example | | | | | | | |
|---|---|---|---|---|---|---|---|---|---|---|---|---|---|
| | | Type | Mw | (mg KOH/g) | (° C.) | 1 | 2 | 3 | 4 | 5 | 6 | 7 | 8 |
| Composition | Hydroxy group-containing | A | 4,500 | 170 | 20 | | | | | | | | |
| | acrylic resin | B | 4,500 | 150 | 40 | 85 | | | 85 | | | 85 | |
| | (parts by mass) | C | 4,700 | 130 | 20 | | 85 | | | 85 | | | |
| | | D | 4,300 | 90 | 90 | | | 85 | | | 85 | | 85 |
| | | E | 6,500 | 150 | 10 | | | | | | | | |
| | | F | 2,900 | 170 | 20 | | | | | | | | |
| | Hydroxy group-containing | | 1,800 | 280 | | 12 | 12 | 12 | 12 | 12 | 12 | 12 | 12 |
| | polyester resin | | | | | | | | | | | | |
| | (parts by mass) | | | | | | | | | | | | |
| | Low-molecular polyol | A | 144 | 780 | | 3 | 3 | 3 | 3 | 3 | 3 | | |
| | (parts by mass) | B | 172 | 652 | | | | | | | | 3 | 3 |
| | | C | 2,000 | 56 | | | | | | | | | |
| | | D | 800 | 140 | | | | | | | | | |
| | Cellulose derivative | | 16,000 | | 85 | 3 | 3 | 3 | 3 | 3 | 3 | 3 | 3 |
| | (parts by mass) | | | | | | | | | | | | |
| | Organic dispersive particles | A | | | | 3 | 3 | 3 | | | | 3 | 3 |
| | (parts by mass) | B | | | | | | | 3 | 3 | 3 | | |
| | Viscosity control agent | | | | | | | | | | | | |
| | (parts by mass) | | | | | | | | | | | | |
| | NCO/OH | | | | | 1.1 | 1.1 | 1.1 | 1.1 | 1.1 | 1.1 | 1.1 | 1.1 |
| | Solid component concentration | | | | | 58 | 58 | 58 | 58 | 58 | 58 | 58 | 58 |
| | (% by mass) | | | | | | | | | | | | |

| | | | | | | | | | |
|---|---|---|---|---|---|---|---|---|---|
| Evaluation | Coating viscosity η₀ | Good | Good | Good | Good | Good | Good | Good | Good |
| | Smoothness A | Good | Good | Good | Good | Good | Good | Good | Good |
| | Smoothness B | Good | Good | Good | Good | Good | Good | Good | Good |
| | Hardness | Good | Good | Good | Good | Good | Good | Good | Good |
| | Initial adhesion | Good | Good | Good | Good | Good | Good | Good | Good |
| | Water resistance | Good | Good | Good | Good | Good | Good | Good | Good |
| | Surface tack | Good | Good | Good | Good | Good | Good | Good | Good |
| | Weatherability | Good | Good | Good | Good | Good | Good | Good | Good |
| | Pot life | Good | Good | Good | Good | Good | Good | Good | Good |

| | | | | OHV | Tg | Comparative Example | | | | | | | |
|---|---|---|---|---|---|---|---|---|---|---|---|---|---|
| | | Type | Mw | (mg KOH/g) | (° C.) | 1 | 2 | 3 | 4 | 5 | 6 | 7 | 8 |
| Composition | Hydroxy group-containing | A | 4,500 | 170 | 20 | | 85 | | | | | | |
| | acrylic resin | B | 4,500 | 150 | 40 | | | | | | | 85 | 85 |
| | (parts by mass) | C | 4,700 | 130 | 20 | 85 | | 85 | | | 85 | | |
| | | D | 4,300 | 90 | 90 | | | | | | | | |
| | | E | 6,500 | 150 | 10 | | | | 85 | | | | |
| | | F | 2,900 | 170 | 20 | | | | | 85 | | | |
| | Hydroxy group-containing | | 1,800 | 280 | | 15 | 12 | | 12 | 12 | 12 | 12 | 12 |
| | polyester resin | | | | | | | | | | | | |
| | (parts by mass) | | | | | | | | | | | | |
| | Low-molecular polyol | A | 144 | 780 | | | 3 | 15 | 3 | 3 | 3 | | |
| | (parts by mass) | B | 172 | 652 | | | | | | | | | |
| | | C | 2,000 | 56 | | | | | | | | 3 | |
| | | D | 800 | 140 | | | | | | | | | 3 |
| | Cellulose derivative | | 16,000 | | 85 | 3 | 3 | 3 | 3 | 3 | | 3 | 3 |
| | (parts by mass) | | | | | | | | | | | | |
| | Organic dispersive particles | A | | | | | | 3 | 3 | 3 | 3 | 3 | 3 |
| | (parts by mass) | B | | | | 3 | | | | | | | |
| | Viscosity control agent | | | | | | | 3 | | | | | |
| | (parts by mass) | | | | | | | | | | | | |
| | NCO/OH | | | | | 1.1 | 1.1 | 1.1 | 1.1 | 1.1 | 1.1 | 1.1 | 1.1 |
| | Solid component concentration | | | | | 58 | 58 | 58 | 58 | 58 | 58 | 58 | 58 |
| | (% by mass) | | | | | | | | | | | | |

| | | | | | | | | | |
|---|---|---|---|---|---|---|---|---|---|
| Evaluation | Coating viscosity η₀ | Poor | Good | Good | Poor | Good | Good | Poor | Good |
| | Smoothness A | Poor | Poor | Good | Poor | Poor | Good | Poor | Good |
| | Smoothness B | — | — | Good | — | — | Good | — | Good |
| | Hardness | Poor | Poor | Poor | Good | Poor | Good | Poor | Poor |
| | Initial adhesion | Good | Good | Good | Good | Good | Good | Good | Good |
| | Water resistance | Good | Good | Poor | Good | Poor | Good | Good | Good |
| | Surface tack | Good | Good | Good | Good | Poor | Poor | Poor | Poor |
| | Weatherability | Good | Good | Poor | Good | Poor | Good | Poor | Good |
| | Pot life | Poor | Poor | Good | Poor | Good | Good | Poor | Good |

Although the clear coating compositions of Examples had high solid contents, the viscosity was sufficiently low even after 4 hours had elapsed after preparation, and the coating films having good appearance and high performance were obtained.

The clear coating compositions of Comparative Examples 1 to 4 and 7 had excessively high viscosity even immediately after preparation, and no smooth coating film could be obtained from them. In addition, since the clear coating compositions after a lapse of 4 hours from the preparation had higher viscosities, they could not be applied, and the smoothness B could not be evaluated. The clear coating compositions of Comparative Examples 5 and 6 were poor in pot life, and the smoothness B was deteriorated. Both the coating films obtained from Comparative Examples 5 and 6 had an LW₁−LW₀ of more than 10.

### INDUSTRIAL APPLICABILITY

The clear coating composition of the present invention can be suitably used for, for example, automobile bodies and automobile components.

This application claims priority based on Japanese Patent Application No. 2021-204948, which was filed in Japan on Dec. 17, 2021, the disclosure of which application is incorporated herein by reference in its entirety.

1. A clear coating composition comprising:
a hydroxy group-containing acrylic resin (a);
a hydroxy group-containing polyester resin (b);
a polyol compound (c) other than the hydroxy group-containing acrylic resin (a) and the hydroxy group-containing polyester resin (b);
a polyisocyanate compound (d);
organic dispersive particles (e); and
a cellulose derivative (f),
wherein the polyol compound (c) has a hydroxyl value of more than 200 mg KOH/g and 1000 mg KOH/g or less and a molecular weight of 100 or more and 1000 or less.

2. The clear coating composition according to claim 1, wherein
in 100 parts by mass of a total solid content of the hydroxy group-containing acrylic resin (a), the hydroxy group-containing polyester resin (b) and the polyol compound (c),
a solid content of the hydroxy group-containing acrylic resin (a) accounts for 60 parts by mass or more and 95 parts by mass or less,
a solid content of the hydroxy group-containing polyester resin (b) accounts for 4 parts by mass or more and 30 parts by mass or less, and
a solid content of the polyol compound (c) accounts for 1 part by mass or more and 10 parts by mass or less.

3. The clear coating composition according to claim 1, wherein the polyol compound (c) has an alicyclic hydrocarbon group.

4. The clear coating composition according to claim 1, wherein at least one hydroxy group of the polyol compound (c) is directly bonded to an alicyclic hydrocarbon group or bonded via a hydrocarbon group having 1 or 2 carbon atoms.

5. The clear coating composition according to 4 claim 1, wherein the hydroxy group-containing acrylic resin (a) has a hydroxyl value of 90 mg KOH/g or more and 190 mg KOH/g or less, a weight average molecular weight of 4000 or more and 6000 or less, and a glass transition temperature of 15° C. or higher and 100° C. or lower.

6. The clear coating composition according to claim 1, wherein the hydroxy group-containing polyester resin (b) has a hydroxyl value of 250 mg KOH/g or more and 500 mg KOH/g or less and a weight average molecular weight of 1500 or more and 2500 or less.

7. The clear coating composition according to claim 1, wherein the polyol compound (c) has a molecular weight of 100 or more and 800 or less.

8. The clear coating composition according to claim 1, wherein the cellulose derivative (f) has a number average molecular weight of 10000 or more and 40000 or less and a glass transition temperature of 80°° C. or higher.

9. The clear coating composition according to claim 1, wherein the clear coating composition has a solid component concentration of 50% by mass or more.

10. The clear coating composition according to claim 1, wherein a viscosity of the clear coating composition measured by a flow cup method at 23° C. is 30 seconds or less.
